(19) United States
(12) Patent Application Publication
(10) Pub. No.: US 2012/0187901 A1
(43) Pub. Date: Jul. 26, 2012

(54) Charger

(76) Inventor: John Snyder, Edina, MN (US)

(21) Appl. No.: 13/353,929

(22) Filed: Jan. 19, 2012

Related U.S. Application Data
(60) Provisional application No. 61/434,632, filed on Jan. 20, 2011.

(51) Int. Cl. H02J 7/00

(52) U.S. Cl. 320/107; 320/160

(57) ABSTRACT

An electronically controlled charger can be used to charge a plurality of ultracapacitors.

### CLAIM OF PRIORITY

This application claims priority to U.S. Provisional Patent Application No. 61/434,632, filed on Jan. 20, 2011, which is incorporated by reference in its entirety.

### TECHNICAL FIELD

This invention relates to a charger.

### BACKGROUND

A charger is a device used to put energy into a secondary power cell or battery by forcing an electric current through it. The charge current depends upon the technology and capacity of the power cell or battery being charged.

### DESCRIPTION OF DRAWINGS

FIG. 1 is a diagram illustrating a charger.

FIG. 2 is a diagram illustrating the current profiles of a charger.

FIG. 3 is a diagram illustrating a charger.

FIG. 4 is a diagram illustrating a charger.

FIG. 5 is a diagram illustrating a charger.

FIG. 6 is a diagram illustrating a charger.

FIG. 7 is a diagram illustrating the current profiles of a charger.

### DETAILED DESCRIPTION

A charger is a device used to put energy into a secondary power cell or battery by forcing an electric current through it. Unlike a battery, an ultracapacitor does not have memory effect problems, loss of capacity, or long recharge times as a power cell. As a capacitive element, the ultra-capacitor has no charge/discharge memory effects allowing charging and discharging up to hundreds of thousands of cycles without any effect on the storage capacity. Also with its very low equivalent series resistance (ESR), these components can be charged and discharged at rates far greater than the best of battery technologies. An electronically controlled charger for charging a power cell, such as ultra-capacitor or battery, is developed.

The charger can include an electrical circuit for transferring energy from an energy reservoir to a storage element. The potential difference inherent at the energy reservoir may be substantially different from that of the storage element. The circuit can provide a means to convert the storage of electrical energy from one potential difference to another with theoretically perfect (100%) efficiency. In practice, the actual efficiency (the percentage of energy lost during the transfer) will be less than 100% due to finite resistive losses in the various components of the circuit as well as all wiring and electrical contacts.

In certain embodiments, the storage device can be charged as quickly as possible, since one of the advantages of an ultra-capacitor over a battery as a storage element is that the ultra-capacitor can accept a charge at a higher rate than a battery cell of comparable capacity. That is, an ultracapacitor can charge in seconds, whereas a battery of comparable capacity is limited to tens of minutes to hours to charge to a full state.

The charger injects short high current pulses into the ultra-capacitor. The fastest charge rate can be achieved by injecting current pulses as close together in time as possible. The charge process can happen in a two-step cycle for each charging pulse. First, a switch is closed causing current to flow into the ultra-capacitor though an inductor (i.e., a choke), which limits the current rise time, then the switch is opened, and the energy stored in the magnetic field of the inductor dissipates as additional current flowing into the ultra-capacitor.

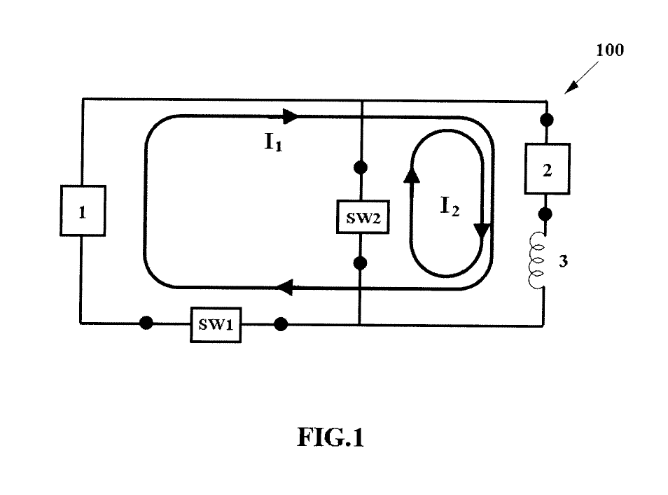

Referring to FIG. 1, charger 100 can include two switches (SW1 and SW2) determining whether electrical current flows along path I₁ or path I₂. Energy reservoir 1 is the source of energy, at a certain potential energy or voltage, to be transferred. Storage element 2, which may be at a different potential energy or voltage, is the destination of the energy. Inductor 3 can assist in the low loss conversion of energy between the two different potential energies or voltages.

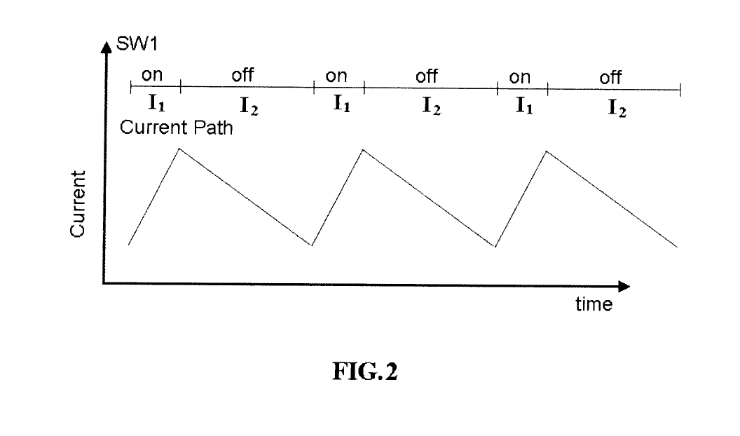

Referring to FIG. 2, SW1 is turned ‘on’ to increase current with time through the inductor along current path I₁ and turned ‘off’ to force current into current path I₂ where it decreases with time. The current profile with time may or may not be linear, and may or may not achieve a value of zero. SW2 can be a Field Effect Transistor (FET), Insulated Gate Bipolar Transistor (IGBT), Bipolar Junction Transistor (BJT), relay or any suitable switch. The state of SW2 is normally the opposite of SW1's state, for example, when SW1 is ‘off’ SW2 is usually ‘on’ and vice versa.

In the event that SW2 is a diode or some other kind of device other than a switch, SW2 will normally be in a forward conduction (high current) mode when SW1 is ‘off’ and in a reverse bias (low current) mode when SW1 is ‘on’.

The circuit can also include a controller for altering the state of SW1 and SW2 depending on the potential difference or voltage across SW1 (Vds), SW2 (Vca), the storage element (Vpm) or some other element in the circuit. The controller may also take into consideration the magnitude of the current in either current path I₁ or current path I₂.

In one embodiment of the invention, SW1 is a FET, IGBT, BJT, or relay, SW2 is a FET, IGBT, BJT, relay, or diode. The energy reservoir is a capacitor, the storage element is an Electrochemical Double Layer Capacitor (EDLC) ultracapacitor or battery or a hybrid of the two.

In another embodiment, the controller turns SW1 ‘on’, and in the event SW2 is a FET, IGBT, BJT, relay or some other kind of switch, turns SW2 ‘off’. This allows for the magnitude of current in current path I₁ to increase, not necessarily linearly with time, to a predetermined value. Once the predetermined magnitude of current is achieved in current path I₁, the controller turns SW1 ‘off’ and, if appropriate, turns SW2 ‘on’ thus forcing the current in current path I₁ into current path I₂. The magnitude of the current in current path I₂ then begins to decrease, not necessarily linearly with time, due to a back-voltage applied across the inductor. The origin of the back-voltage is the potential differences across SW2 and the storage element. The magnitude of the current in current path I₂ is allowed to decrease to a predetermined value, not necessarily zero, whereupon SW1 is turned ‘on’ again and the cycle is repeated. This process continues until the storage element is sufficiently charged.

In some embodiments, when a collapsing current in current path I₂ falls to zero (or nearly), the next cycle can begin. To begin the next cycle, the current is sensed. Traditionally, a small resistor can be placed in series with the current to be sensed and the voltage drop across that resistor is measured to detect when the current has declined sufficiently. But there can be several disadvantages to placing a current sense resistor into the circuit. One problem is that the resistor can get hot, wasting power and therefore reducing efficiency. To overcome this shortcoming, the resistor can be made very small—a fraction of an ohm. One difficulty that can arise from this solution is that it becomes difficult (i.e., more costly) to control the precision of the resistor value, and therefore the accuracy of the current sense mechanism. The method used in the charger described here takes advantage of the inherent forward voltage drop of an already existing flyback diode (SW2) and takes that voltage as an indication of the flow of current due to the collapsing magnetic field.

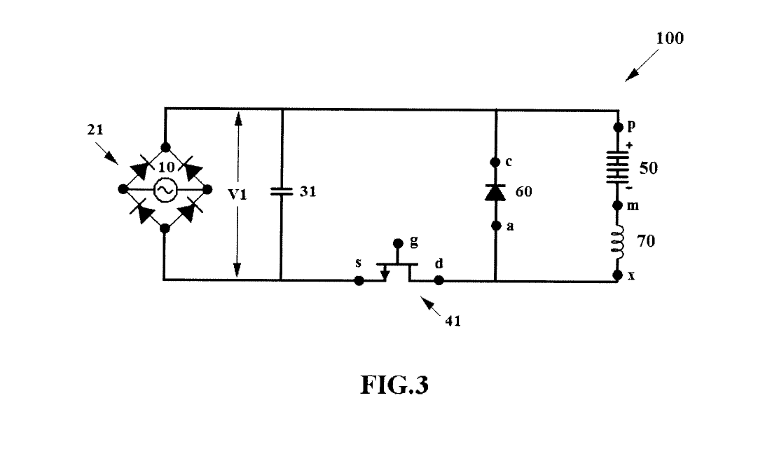

In some embodiments, referring to FIG. 3, charger 100 can include full-wave bridge 21 to rectify AC current. Full-wave bridge 21 can include a plurality of diodes and convert the whole of the input waveform to one of constant polarity at its output. Full-wave bridge 21 in combination with capacitor 31 can convert both polarities of the input waveform to DC. As shown in FIG. 3, four diodes can be arranged in a way called a diode bridge or bridge rectifier without a transformer (full wave bridge rectifier is a commonly used term and does not need to be defined here). The output voltage of full-wave bridge 21 can be in any suitable range, such as 170V or 330V. The output power of full-wave bridge 21 can be stored in capacitor 31. Capacitor 31 can include an electrolytic storage capacitor or any suitable capacitor. Charger 100 can include FET 41. In some embodiments, FET 41 can be a power field effect transistor, IGBT or any suitable switch. FET 41 can be a power FET capable of handling over 200 amp peak current. FET 41 can be an n-channel FET (nFET). Diode 60 can be included as a flyback diode.

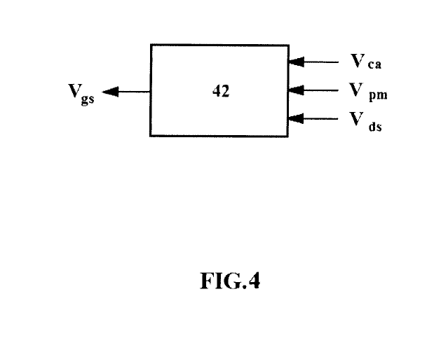

Referring to FIG. 4, control circuit 42 can monitor more than two voltages across the circuit (V_{ca}, Vₚₘ, and V_{ds}) and decides when to generate a square wave pulse to the gate of the FET (V_{gs}). The duration of the pulse can vary and the time between pulses can vary as well. The Vgs pulse can stay high until the current through the FET reaches a predetermined maximum value.

In the case of the 120 and 240 V AC chargers, this can be accomplished by a fixed pulse duration and in this case V_{ds} is not used. For the 12 V AC charger, however, the pulse duration can vary depending on the status of the ultracapacitors (Vₚₘ) and V_{ds} can be used to set the pulse duration. Vₚₘ can be used to detect end-of-charge and to shut off the series of pulses to V_{gs}. V_{ca} can be used to detect when the current through inductor 70 has fallen to zero, then it can trigger the start of another pulse to V_{gs}.

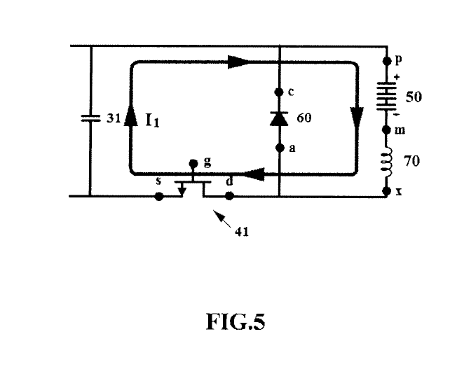

Referring to FIG. 5, charging of ultracaps 50 can be triggered by a pulse to FET 41 (V_{gs}), causing current to flow as shown. No current flows through diode 60 at this point and current through FET 41 can ramp up in a more-or-less linear manner because of the effect of inductor 70. For the 120 and 240 V_{ac} chargers, the sum of the voltages across FET 41 and ultracap 50 (˜10V) can be small compared to the DC voltage across storage caps 31 (˜170, 340 V), thus there can be a constant linear current ramp through inductor 70 regardless of the charge state of ultracaps 50 (Vₚₘ). In this case, a pulse of constant duration will suffice to ramp the current up to a specified value if the current starts at zero. In some embodiments, ultracaps 50 can include at least one electric double-layer capacitor (EDLC).

For the 12 Vdc charger, the sum of the voltages across FET 41 and ultracap 50 (˜10V) can be significant compared to the voltage on the storage capacitor 31 (˜12V). In this case the duration of the pulse width to the gate will depend on the charge state of the EDLC ultracap 50. The controller can use either Vds across FET 41 or Vmx across inductor 70, or both, to set the gate pulse duration.

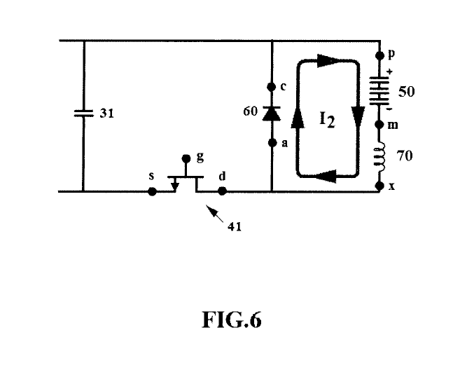

When the current through the FET 41 reaches a predetermined value, FET 41 can be turned off. As shown in FIG. 6, electrical current flows along path I₂ through diode 60. The magnitude of the current can slowly ramp down due to voltage (V_{ac}+Vₚₘ) across inductor 70. When the current reaches zero, control circuit (42 in FIG. 4), which is monitoring the diode forward voltage V_{ac}, can trigger another pulse to the gate of FET 41(V_{gs}).

FET 41 can be turned on after the current in inductor 70 reaches a predetermined value, such as zero, which can be detected by monitoring the diode forward voltage (V_{ac}). Thereby, it can also prevent any potential damage to FET caused by high currents at high voltages.

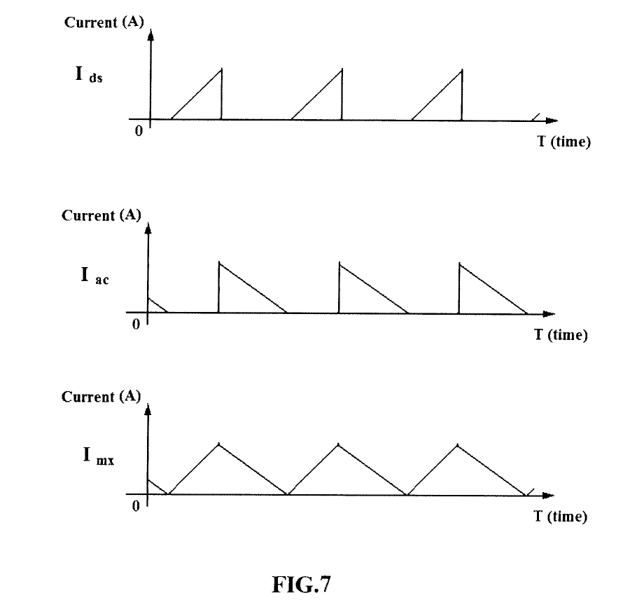

As shown in FIG. 7, the current through FET 41, diode 60, and inductor 70 are represented as I_{ds}, I_{ac}, and Iₘₓ. The currents can have any suitable profile, such as different pulse length, ramp shape and/or peak value. In one aspect, an electronically controlled charger for charging a power cell can include a rectifier connected to an alternating current power source, a storage module connected to the rectifier for storing the electric power, and a control module connected to both the storage module and the power cell for controlling the duration of the power cell charging cycle and charging current profile. The rectifier can include a full-wave bridge. The charger can include a capacitor for smoothing the power output of the rectifier. The power cell can include at least one ultracapacitor. The power cell can include at least one battery. The control module can include a field effect transistor, insulated gate bipolar transistor or any kind of switch. The control module can include a pulse generator for generating a pulse to control the transistor.

The charger can include an inductor connected in series with the power cell. A power cell charging cycle can include a current increasing period. The power cell charging cycle comprises a current decreasing period, after the current value reaches a predetermined value.

In one aspect, a method of charging a power cell can include charging the power cell with a first charging current flowing through a first charging circuitry, wherein the first charging current is increasing, and charging the power cell with a second charging current flowing through a second charging circuitry after the first charging current reaches a predetermined current value. The second charging current can be decreasing. The method can include charging the power cell with the first charging current flowing through the first circuitry after the second charging current reaches zero.

The method can include monitoring the voltage across a switch component of the second charging circuitry during charging the power cell with the second charging current. The method can further include switching back to charging the power cell with a first charging current by changing the status of the switching component when the voltage across the switch component reaches a predetermined value. The predetermined value of the voltage across the switch component can be as low as zero volts. The switch component can include a diode.

The power cell can include at least one ultracapacitor. The power cell can include at least one battery. The method can include rectifying a power input from an alternating current power source.

The method can include generating a pulse to control a transistor to switch from the first charging circuitry to the second charging circuitry. The first charging circuitry and the second charging circuitry can share at least one component. The method can include controlling a charging cycle length by changing the predetermined current value. The method can include storing the rectified power input by a storage capacitor.

In another aspect, a charger for charging an energy storage element can include an energy source at a first potential energy or voltage. The energy source can supply energy to the energy storage element by an electrical current. The energy storage element can be at a second potential energy or voltage. The charger can include at least one switch electrically connected to the energy source for determining whether the electrical current flows along a first current path or a second current path.

The first potential energy or voltage can be different from the second potential energy or voltage. The charger can include an inductor for assisting a low loss conversion of energy between the two different potential energies or voltages. The energy storage element can include at least one ultracapacitor. The switch can include a field effect transistor.

A number of embodiments of the invention have been described. Nevertheless, it will be understood that various modifications may be made without departing from the spirit and scope of the invention. For example, although the invention is described in reference to an electronically controlled charger, it can apply to any other suitable charging technique, such as any suitable ultracapacitor charging technique. It should also be understood that the appended drawings are not necessarily to scale, presenting a somewhat simplified representation of various preferred features illustrative of the basic principles of the invention.

What is claimed is:

1. An electronically controlled charger for charging a power cell comprising:
a rectifier connected to an alternating current power source, wherein the rectifier comprises a full-wave bridge;
a storage module connected to the rectifier for storing the electric power; and
a control module connected to both the storage module and the power cell for controlling the duration of a power cell charging cycle and charging current profile.

2. The charger of claim 1 further comprising a capacitor for smoothing the power output of the rectifier.

3. The charger of claim 1, wherein the power cell comprises at least one ultracapacitor.

4. The charger of claim 1, wherein the power cell comprises at least one battery.

5. The charger of claim 1, wherein the control module comprises a field effect transistor.

6. The charger of claim 1, wherein the control module comprises an insulated gate bipolar transistor.

7. The charger of claim 1, wherein the control module comprises a pulse generator for generating a pulse to control the transistor.

8. The charger of claim 1, further comprising an inductor connected in series with the power cell.

9. The charger of claim 1, wherein a power cell charging cycle comprises a current increasing period.

10. The charger of claim 9, wherein the power cell charging cycle comprises a current decreasing period, after the current value reaches a predetermined value.

11. A method of charging a power cell, comprising:
charging the power cell with a first charging current flowing through a first charging circuitry, wherein the first charging current is increasing; and
charging the power cell with a second charging current flowing through a second charging circuitry after the first charging current reaching a predetermined current value, wherein the second charging current is decreasing.

12. The method of claim 11 further comprising monitoring the voltage across a switch component of the second charging circuitry during charging the power cell with the second charging current.

13. The method of claim 12 further comprising switching back to charging the power cell with a first charging current by changing the status of the switching component when the voltage across the switch component reaches a predetermined value.

14. The method of claim 13, wherein the predetermined value of the voltage across the switch component is about zero volts.

15. The method of claim 12, wherein the switch component comprises a diode.

16. The method of claim 11, further comprising charging the power cell with the first charging current flowing through the first circuitry after the second charging current reaches zero.

17. The method of claim 11, wherein the power cell comprises at least one ultracapacitor.

18. The method claim 11, wherein the power cell comprises at least one battery.

19. The method of claim 11, further comprising rectifying a power input from an alternating current power source.

20. The method of claim 11, further comprising generating a pulse to control a transistor to switch from the first charging circuitry to the second charging circuitry.

21. The method of claim 11, wherein the first charging circuitry and the second charging circuitry share at least one component.

22. The method of claim 11, further comprising controlling a charging cycle length by changing the predetermined current value.

23. The method of claim 11, further comprising storing the rectified power input by a storage capacitor.

24. A charger for charging an energy storage element comprising:
an energy source at a first potential energy or voltage, wherein the energy source supplies energy to the energy storage element by an electrical current, the energy storage element at a second potential energy or voltage; and
at least one switch electrically connected to the energy source for determining whether the electrical current flows along a first current path or a second current path.

25. The charger of claim 24, wherein the first potential energy or voltage is different from the second potential energy or voltage.

26. The charger of claim 25, further comprising an inductor for assisting a low loss conversion of energy between the two different potential energies or voltages.

27. The charger of claim 24, wherein the energy storage element comprises at least one ultracapacitor.

28. The charger of claim 24, wherein the switch comprises a field effect transistor.
